(19) United States
(12) Patent Application Publication
(10) Pub. No.: US 2018/0009177 A1
(43) Pub. Date: Jan. 11, 2018

(54) PRODUCTION MOLD FOR A ROTOR BLADE

(71) Applicant: SENVION GmbH, Hamburg (DE)

(72) Inventor: Urs Bendel, Fockbek (DE)

(21) Appl. No.: 15/640,839

(22) Filed: Jul. 3, 2017

(30) Foreign Application Priority Data
Jul. 5, 2016 (DE) 10 2016 008 125.2

(51) Int. Cl. B29C 65/00; B29C 33/28; B29C 65/48; B29L 31/08

(52) U.S. Cl. CPC B29C 66/547; B29C 65/48; B29C 33/28; B29L 2031/085

(57) ABSTRACT

A production mold for a rotor blade of a wind turbine is provided, having two mold half-shells each with an open side and arranged in a retaining device, wherein the two retaining devices are connected to one another in an articulated manner and can be swung back and forth from an open position, in which the two mold half-shells are arranged one beside the other with their open sides oriented upward, into a closed position, in which the two mold half-shells are arranged one above the other with their open sides oriented toward one another, with a plurality of two-component closures, of which the one component is arranged on the first retaining device and of which the other component is arranged on the second retaining device, and wherein the two components can be closed and opened again by means of at least one actuator, by way of at least two separate movements of the component or of the two components.

### RELATED APPLICATION

This application is filed under 35 U.S.C. §119 and claims the benefit of priority to German Patent Application No. DE 10 2016 008 125.2 filed on Jul. 5, 2016, which is hereby incorporated by reference in its entirety herein to provide continuity of disclosure.

### TECHNICAL FIELD

The invention relates to a production mold for a rotor blade of a wind turbine.

### BACKGROUND

Production molds for rotor blades of wind turbines are, of course, well known in the prior art.

According to WO 2010/076605 A1, two mold half-shells mounted on support structures are pivoted in relation to one another until peripheries of the mold half-shells are positioned one above the other, and a rotor-blade half-shell is positioned in each of the two mold half-shells. Between the rotor-blade half-shells, an adhesive-bonding compound is applied to the periphery of the lower rotor-blade half-shell. The two mold half-shells are engaged one inside the other by means of a driven hook, the hook executing a combined rotary and translatory movement, wherein the two movements are coupled directly to one another.

WO 2010/103490 A1 describes a closing mechanism for the two mold half-shells of a production mold, wherein the closure is likewise based on a hook mechanism. The hook, in turn, is arranged on a cylinder, which executes a translatory movement, and therefore the hook itself carries out a combined translatory and rotary movement, wherein the two movements are not separate from one another. The disadvantage with the two production-mold-closure mechanisms described is that the two closure components have to be positioned fairly precisely in relation to one another in order for the rod to be located along the one-dimensional movement line of the hook.

### SUMMARY

It is therefore an object of the present invention, as far as a first aspect is concerned, to provide a production mold of the type mentioned in the introduction with another closure, which avoids the aforementioned disadvantages.

It is an object of the present invention, as far as a second aspect is concerned, to provide a method which can better close a production mold of a rotor blade of a wind turbine.

As far as the first aspect is concerned, the object is achieved by a production mold for a rotor blade of a wind turbine comprising a first mold half-shell and a second mold half-shell, wherein the first mold half-shell is arranged in a first retaining device and the second mold half-shell is arranged in a second retaining device, wherein the first mold half-shell comprises a first open side and the second mold half-shell comprises a second open side, wherein the first retaining device is connected to the second retaining device in an articulated manner, wherein the first retaining device and the second retaining device are movable from an open position, in which the second mold half-shell is beside the first mold half-shell and the first open side of the first mold half-shell and the second open side of the second mold half-shell are oriented upward, to a closed position, in which the second mold half-shell is above the first mold half-shell with the first open side of the first mold half-shell oriented toward the second open side of the second open half-shell, and a plurality of closures, wherein each closure of the plurality of closures comprises a first component and a second component, wherein the first component of each closure of the plurality of closures is arranged on the first retaining device and the second component of each closure of the plurality of closures is arranged on the second retaining device, and wherein the first component and the second component of each closure of the plurality of closures is opened and closed by at least one actuator, wherein opening and closing of each closure of the plurality of closures is by at least two separate movements of either one or both of the first component and the second component.

The production mold is intended for producing a rotor blade of a wind turbine, wherein the rotor blade is a laminate component which is made up at least of two rotor-blade half-shells and each of the rotor-blade half-shells is produced by lamination, wherein layers made of woven textile fabric and/or woven plastic fabric, containing for example carbon fibers oriented in certain directions, are positioned one above the other. It is possible here for use to be made, in addition, of foam cores and/or balsa material. These layers positioned one above the other are then infused with a resin system in an infusion method, wherein the term “infusion” here should be understood in general terms; the specific type of infusion method is not what matters. It is also possible, however, to use other methods of producing a component from fiber composites.

The production mold comprises two mold half-shells each with an open side, wherein each of the mold half-shells is arranged on a retaining device. The one mold half-shell is arranged on the first retaining device and the other mold half-shell is arranged on the second retaining device. The two retaining devices can be connected to one another in an articulated manner. They can be moved back and forth between an open position, in which the two mold half-shells are arranged one beside the other with their open sides oriented upward, and a closed position, in which the two mold half-shells are arranged one above the other with their open sides oriented toward one another. The terms “upward” and “downward” here should be understood as relating to the force of gravity.

According to the invention, the production mold has a plurality of, i.e. at least two, three, four or more, two-component closures, of which the one component is arranged on the first retaining device and of which the other component is arranged on the second retaining device. The components here are fixed on the retaining devices, and they can therefore also withstand high levels of loading.

The two components can be closed and opened again preferably automatically and by means of at least one actuator, by way of at least two separate movements of one component or of the two components. The components can be actuated automatically, i.e. they need not be actuated manually. The closure is controlled electronically, pneumatically, hydraulically, etc., from the outside, it being possible for individual steps of the closing operation to be controlled separately.

Each of the closures has at least one actuator. The closures can also have two or more actuators. The closure can have precisely one actuator. In another embodiment of the invention, the one component of the closure has precisely one actuator and the other component of the closure has precisely another actuator. The two actuators are spaced apart from one another and can be controlled preferably separately.

The at least two movements of the components or of the component are separate. They are independent of one another. Each of the closures therefore has in particular two degrees of freedom.

It is therefore quite possible for a movement of the one component to be executed only over a short distance, then to be supplemented by the other component moving a short distance and then for the first movement to be executed again over a further distance.

The one component can have an eyelet, which is driven by an actuator, and the other component can have a bolt, which is driven via another actuator and, in a closed state, is introduced into the eyelet and, in the open state, is drawn out of the eyelet. The bolt can be guided into a first holder and, in the open state, is in contact only with the first holder, whereas, in the closed state, it is guided through the eyelet and also introduced into a second holder, with which it is also in contact.

In another embodiment of the closure according to the invention, the one component has an extension arm, which can be rotated, while the other component has a bearing means, over which the extension arm can be rotated when the production mold is swung together. Furthermore, the extension arm can be displaced in a translatory manner in one direction, the direction being oriented from the extension arm in the direction of the bearing means.

In another embodiment, the one actuator or the other has a rod, which is guided in a holder and at the free end of which the eyelet or the extension arm is arranged. A holder here can be understood to mean a cylinder and the rod can be understood to mean a cylinder rod which is driven pneumatically or hydraulically by the cylinder. It is also conceivable, however, to have electric drives or other kinds of drive.

The two mold half-shells, in the closed state of the production mold, can form a gap which runs along between their peripheries. The gap can extend over the entire extent of the two mold-half-shell peripheries arranged one above the other, both along the width and along the longitudinal direction of the peripheries.

Rotor-blade half-shells are produced in the mold half-shells and likewise each have a periphery which runs along the periphery of the mold half-shells, the peripheries of the mold half-shell and those of the rotor-blade half-shell preferably being aligned.

All the peripheries can be arranged one beside the other and are aligned, and, there can be alignment of the peripheries throughout. As a result, the gap between the peripheries of the mold half-shells corresponds to the gap between the peripheries of the rotor-blade half-shells at the locations where the peripheries are aligned.

An adhesive-bonding agent is applied to the peripheries of the rotor-blade half-shells, via which the two rotor-blade half-shells are produced in the mold half-shells, and already hardened, are adhesively bonded to one another. This means that the adhesive-bonding compound is applied to at least one periphery of a rotor-blade half-shell which is positioned in the mold half-shell, and the two rotor-blade half-shells are pushed onto one another along their peripheries.

In yet another embodiment, the two retaining devices are provided with spacers which, in the closed state, space the two mold half-shells apart from one another to the extent where the gap forms with a defined height, pin a reproducible manner, between the peripheries of the rotor-blade half-shells.

The spacers can be designed in the form of a pair of pressure-exerting elements, wherein in each case one of the pressure-exerting elements is fixed on one of the retaining devices, and it therefore withstands the necessary tensile and compressive loading. In the closed state of the production mold, the pressure-exerting elements of a pair are located in each case one upon the other and are in contact with one another.

The retaining device and/or the second retaining device are/is designed in the form of a steel framework. A steel framework is a framework structure made up of steel supports and/or steel tubes.

As far as its other aspect is concerned, the invention is achieved by a method of producing a rotor blade of a wind turbine comprising producing a first rotor-blade half-shell and a second rotor-blade half-shell in a production mold comprising a first mold half-shell and a second mold half-shell, wherein the first mold half-shell comprises a first open side and the second mold half-shell comprises a second open side, wherein the first rotor-blade half-shell is produced in the first mold half-shell and the second rotor-blade half-shell is produced in the second mold half-shell, wherein the first mold half-shell is arranged in a first retaining device and the second mold half-shell is arranged in a second retaining device, wherein the first retaining device is connected to the second retaining device in an articulated manner, wherein the first retaining device and the second retaining device are movable from an open position, in which the second mold half-shell is beside the first mold half-shell and the first open side of the first mold half-shell and the second open side of the second mold half-shell are oriented upward, to a closed position, in which the second mold half-shell is above the first mold half-shell with the first open side of the first mold half-shell oriented toward the second open side of the second open half-shell, and a plurality of closures, wherein each closure of the plurality of closures comprises a first component and a second component, wherein the first component of each closure of the plurality of closures is arranged on the first retaining device and the second component of each closure of the plurality of closures is arranged on the second retaining device, and wherein the first component and the second component of each closure of the plurality of closures is opened and closed by an actuator, wherein opening and closing of each closure of the plurality of closures is by at least two separate movements of either one or both of the first component and the second component.

The method is suitable for being implemented using one of the aforementioned production molds.

A respective rotor-blade half-shell is produced in each of the two mold half-shells. Once the rotor-blade half-shells, in the form of laminate components, have been infused with resin and/or at least largely hardened, and can be fully hardened, the two mold half-shells are swung together one above the other, and therefore the peripheries of the two rotor-blade half-shells located in the mold half-shells are positioned one above the other.

An adhesive-bonding agent can be applied beforehand to at least one of the peripheries of the rotor-blade half-shells, and the two mold half-shells are swung together to the extent where both the periphery of the one rotor-blade half-shell and the periphery of the other rotor-blade half-shell rest opposite one another on the layer of adhesive-bonding compound.

The two mold half-shells can be closed using two-component closures according to the invention, of which the one component is arranged on first retaining device and of which the other component is arranged on the second retaining device. The two components of each closure are closed by two separate movements of one component or of the two components.

An eyelet, which is provided on the first component, can be displaced in a translatory manner in one direction and for a bolt, which is arranged on the second component, to be displaced likewise in a translatory manner in one direction until the bolt projects through the eyelet. The eyelet is then displaced in a translatory manner in the opposite direction. The bolt movement and the movement direction of the eyelet can run perpendicularly to one another, or approximately perpendicularly to one another, it also can have an angle of 90°±5°, ±10°, or ±15°, between the two translatory movements. The eyelet is displaced in a translatory manner in the opposite direction until the bolt, which is carried along by it, is drawn toward the mold half-shell to a sufficient extent for the gap between the two rotor-blade half-shells to have the predetermined gap width. The pushed-together gap can be filled fully with adhesive-bonding agent, and this establishes a sufficiently firm adhesive-bonding connection between the peripheries of the two rotor-blade half-shells.

In another embodiment of the method according to the invention, an extension arm, which is arranged on the one component, is rotated, the extension arm can be arranged on a rod about the longitudinal direction of which the extension arm is rotated, until it is positioned above a bearing means, which is arranged on the other component. Following the rotation of the extension arm, the extension arm is spaced apart from the bearing means, i.e. the extension arm and bearing means are not in contact, but the bearing surfaces can be essentially parallel to one another and at a clear distance from one another.

The extension arm is then displaced in a translatory manner in the direction of the bearing means until the extension arm is in contact with the bearing means. The extension arm, however, can be displaced yet further, by means of the actuator, so that, under the action of force, it presses the other mold half-shell onto the mold half-shell, or onto the applied adhesive, until the gap has reached the predetermined gap width.

The adhesive-bonding agent can be applied in the first instance in a layer thickness of 3 to 4 cm, whereas the gap between the two rotor-blade-half-shell peripheries, which results from the mold half-shells being pushed together, is only approximately 1 cm. The layer of adhesive-bonding agent is compressed to the gap width and pushed away laterally out of the gap in the process.

Other layer thicknesses of adhesive-bonding agent are, of course, also contemplated; it is also possible for the layer of adhesive-bonding compound to be applied in thicknesses of 4 to 5 cm or 5 to 6 cm, whereas the gap width once the mold half-shells have been pushed together is approximately 1 to 1.5 cm or even 2 cm.

The invention will be described with reference to two exemplary embodiments in five figures, in which:

### BRIEF DESCRIPTION OF THE DRAWINGS

FIG. 1 shows a perspective view of a production mold for a rotor blade of a wind turbine,

FIG. 2a shows a first embodiment of a closure of the production mold in FIG. 1 in an open state,

FIG. 2b shows the closure in FIG. 2a in a closed state,

FIG. 3a shows a second embodiment of a closure in an open position, and

FIG. 3b shows the closure in FIG. 3a with the production mold swung together and in a closed state.

### DETAILED DESCRIPTION

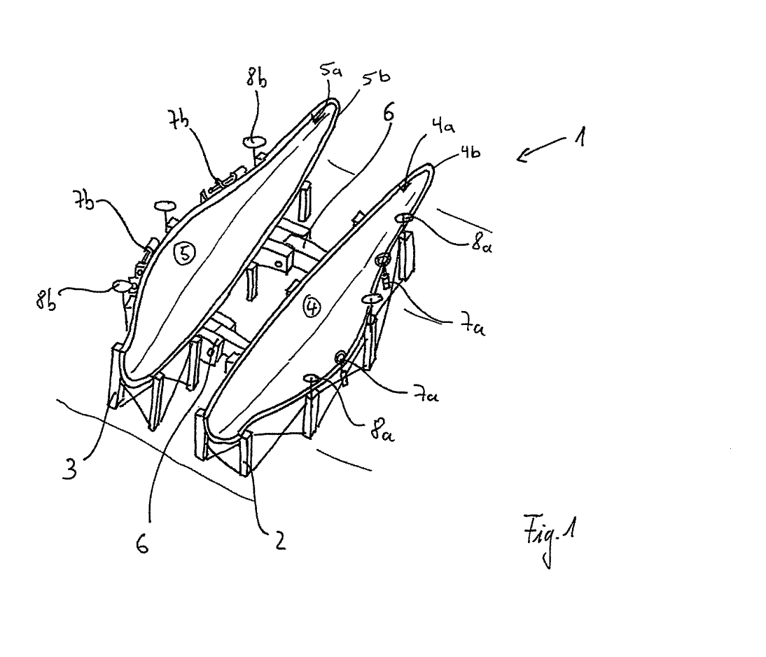

The production mold 1 illustrated in FIG. 1 is intended for producing a rotor blade of a wind turbine.

In this example, which should not be understood as being restrictive, the production mold 1 has two steel frameworks, a first steel framework 2 and a second steel framework 3, connected to one another in an articulated manner. A respective mold half-shell 4, 5 is arranged in each of the two steel frameworks 2, 3. In FIG. 1, the one right-hand first steel framework 2, which is at the front, is fixed in position on the floor of an assembly facility, whereas the other, left-hand second steel framework 3, which is the upper steel framework in FIG. 1, is arranged in an articulated manner, for example by way of seven articulations 6, for pivoting relative to the first steel framework 2. The first mold half-shell 4 is mounted in the first steel framework 2 and the second mold half-shell 5 is mounted in the second steel framework 3. The first and second mold half-shells 4 and 5 are connected to their respective first and second steel frameworks 2 and 3. The connection allows slight relative movements on account of different extents of thermal expansion; otherwise, the connection is fixed in position in relative terms. The first mold half-shell 4 can be used for producing a pressure side of the rotor blade and the second mold half-shell 5 can be used for producing the suction side of the rotor blade.

The first retaining device 2 and the second retaining device 3 comprise, for example, a steel framework, each can comprise a steel-tube structure; the first and second mold half-shells 4 and 5 each can comprise, for example, laminate components. The first and second mold half-shells 4 and 5 each has an open side and a closed side. The first mold half-shell 4 includes first open side 4a, and the second mold half-shell 5 includes the second open side 5a. In the open position of the production mold 1, which is illustrated in FIG. 1, the first and second open sides 4a and 5a of the first and second mold half-shells 4 and 5 are arranged one beside the other and are oriented upward—wherein “upward” and “downward”, within the context of this application, are terms relating to earth or ground level. In a direction oriented away from the open side, heating devices may be integrated in the first and second mold half-shells 4 and 5.

During the method of producing the rotor blade, in the first instance the two rotor-blade half-shells, from which the subsequent rotor blade is assembled, are produced in the production mold 1. For this purpose, in the first instance a number of layers, for example fiber-containing layers, foams, balsa material, etc., are positioned one above the other and/or one beside the other in each of the first and second mold half-shells 4 and 5, according to FIG. 1. The layers arranged in this way can form a dry semi-finished product. The semi-finished product is impregnated with a resin system in methods such as, for example, Resin Injection Molding (RIM) or Resin Transfer Molding (RTM).

Once the rotor-blade half-shells 20 and 21 have been completed and hardened, the second mold half-shell 5, with the rotor-blade half-shell produced in the second mold half-shell 5, can be pivoted over the first mold half-shell 4 with the aid of the second steel framework 3. The production mold 1 is swung shut. The other rotor-blade half-shell has a sufficient level of adhesion to the inside of the second mold half-shell 5, or is secured by a so-called closing vacuum and/or additional mechanical securing means, so as not to fall out of the second mold half-shell 5 when the second steel framework 3 is pivoted.

Mutually facing longitudinal sides of the first and the second steel frameworks 2 and 3 are connected to one another via the articulations 6 and thus allow the second steel framework 3 to pivot back and forth, while those longitudinal sides of the first and second steel frameworks 2 and 3 which are located opposite the articulations 6 are provided with a plurality of components 7a and 7b of a plurality of closures 7 and with interacting components 8a and 8b of spacers 8.

When the production mold 1 is swung together, a first pressure-exerting element 8a and a second pressure-exerting element 8b of a respective spacer 8 strike against one another and support the first and second steel frameworks 2 and 3 in relation to one another on their longitudinal sides located opposite the articulations and keep them spaced apart by a predetermined distance d. The spacers 8 are length-adjustable in the vertical by a few centimeters. Provided between the spacers 8, along the longitudinal sides of the first and second steel frameworks 2 and 3 and of the first and second mold half-shells 4 and 5, are closures 7 according to the invention, which are in contact with the first and second steel frameworks 2 and 3 and by means of which the two steel frameworks, together with the two mold half-shells, can be closed in relation to one another.

Before swing action parts, that is to say the second steel framework 3 and the second mold half-shell 5, are swung onto the fixed-position parts, that is to say the first steel framework 2 and the first mold half-shell 4, the peripheries of the rotor-blade half-shells and the free peripheries of the crosspieces adhesively bonded in the fixed-position rotor-blade half-shell are provided with an adhesive-bonding agent layer 9. The adhesive-bonding agent layer 9 can have a thickness of 2 to 4 cm. The thickness of the adhesive-bonding agent layer 9 applied is greater than the thickness of the subsequently hardened layer of adhesive. The hardened adhesive has a thickness of approximately 1-15 mm, and therefore, once the first and second mold half-shells 4 and 5 have been swung shut, the first and second mold half-shells 4 and 5 have to be drawn toward one another by the closures 7 to the extent where the adhesive-bonding agent layer 9 measuring 2 to 4 cm is compressed to a final thickness of approximately 1-15 mm. The adhesive-bonding agent 9 that is pushed out is collected on the outside of the rotor blade. The closures 7, each having one or two actuators 10 and 11, make it possible for the two mold half-shells to be drawn together. The number of actuators 10 and 11 per closure 7 depends on the type of closure 7.

The first actuator 10 and the second actuator 11 are designed overall such that they apply a force sufficient to compress the first and second mold half-shells 4 and 5, counter to the resistance of the adhesive-bonding agent layer 9 in a thickness measuring 2 to 4 cm, to the extent where the adhesive-bonding agent layer 9 achieves its final thickness of 1-15 mm. the force which actually has to be applied by each of the first and second actuators 10 and 11 depends, of course, on the size of the surface area of the adhesive-bonding agent layer 9, that is to say on the length of the rotor blade and/or of the first and second mold half-shells 4 and 5 and on the number of first and second actuators 10 and 11 arranged along the two longitudinal edges of the first and second steel frameworks 2 and 3.

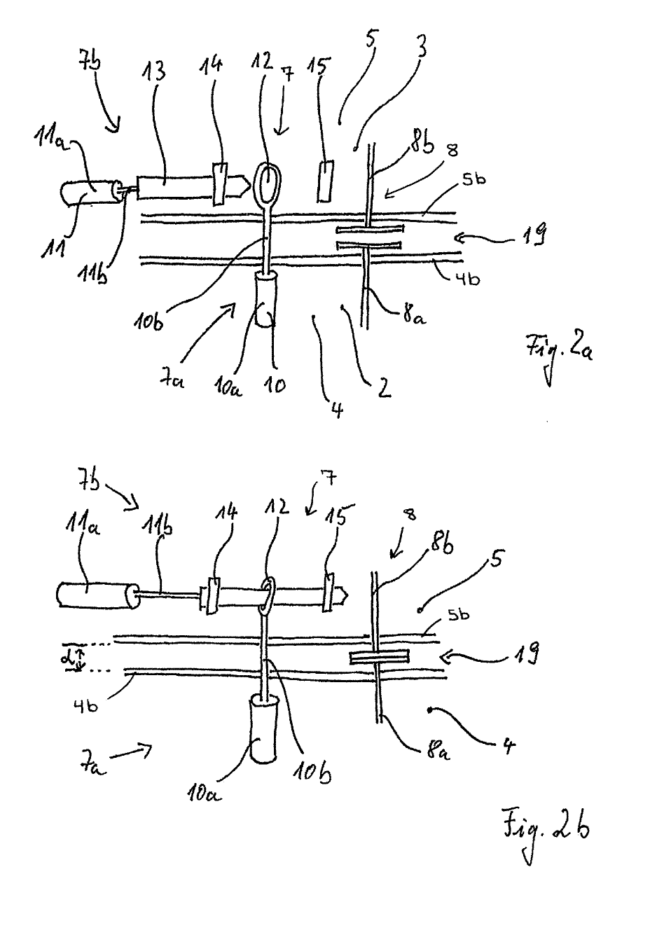

FIG. 2a illustrates a detail of a gap 19 in the production mold 1 between the pivotable mold parts, the second steel framework 3 and the second mold half-shell 5, and the fixed-position mold parts, the first steel framework 2 and the first mold half-shell 4, the production mold 1 being in a swung-together, but not yet pushed-together state, i.e. in an open state. The first mold half-shell 4 comprises a first periphery 4b, and the second mold half-shell 5 comprises a second periphery 5b. The gap 19 is formed between the first periphery 4b and the second periphery 5b. The inner sides of the first and second peripheries 4b and 5b of the first and second mold half-shells 4 and 5 have arranged on them a respective periphery of the associated rotor-blade half-shells. The first and second peripheries 4b and 5b of the first and the second mold half-shells 4 and 5 and the peripheries of the rotor-blade half-shells are aligned with one another.

The adhesive-bonding agent layer 9 is applied to the periphery of the fixed-position rotor-blade half-shell, said adhesive-bonding agent layer 9 extending over the entire width of the peripheries of the rotor-blade half-shells and covering the periphery running around the rotor-blade half-shell, wherein it is only the root region, which has a circular opening as seen in the cross section taken perpendicular to the longitudinal direction, which has no rotor-blade-half-shell peripheries which are to be adhesively bonded to one another.

The closure 7 illustrated in FIG. 2a is of two-component design. The closure 7 has a first actuator 10 belonging to a first closure component 7a, which is permanently mounted on the first steel framework 2, and a second actuator 11 belonging to a second closure component 7b, which is permanently mounted on the second steel framework 3. The first and second closure components 7a and 7b interact. In the swung-open position of the production mold 1, the first and second actuators 10 and 11 are arranged in their open position, i.e. the first actuator 10 has been drawn in, while the second actuator 11 has likewise been drawn in. The first and second actuators 10 and 11 are shown in the form of hydraulic cylinders 10a and 11a with a piston rod 10b and 11b. Other embodiments of the first and second actuators 10 and 11, however, are also contemplated; they may be in the form of electric drives, pneumatic drives or other kinds of drive. The hydraulic systems which control the first and second actuators 10 and 11, and have a liquid-supply line and liquid-discharge line and a control means with pumps, etc., are not illustrated in FIGS. 2a and 2b.

The cylinder 10a has extending from it a piston rod 10b, which is movable relative to the cylinder 10a and has an eyelet 12 mounted at its free end, which is the upper end in FIG. 2a. The eyelet 12 has its opening surface arranged perpendicularly to the longitudinal direction L of the mold half-shells. The eyelet may also be arranged for rotation about the piston rod 10b. In some embodiments of the closure, the piston rod 10b rotates automatically as it retracts and extends, and therefore, in the retracted, open state, the eyelet 12 has its opening cross section arranged parallel to the longitudinal direction of the mold half-shells and, when the piston rod 10b extends, the eyelet 12 rotates through 90° either in the clockwise direction or in the counterclockwise direction and, in the swung-shut and in the closed state, the eyelet 12 then has its cross-sectional surface area arranged perpendicularly to the longitudinal direction of the mold half-shells. The eyelet 12 interacts with a bolt 13, which is arranged on another piston rod 11b of the other hydraulic cylinder 11 a and can be introduced into the eyelet 12. A cross section of the bolt 13 over the entire longitudinal extent of the latter is therefore smaller than an inner cross section of the eyelet 12.

FIG. 2a also illustrates a first and a second holder 14 and 15 of the bolt 13. In the non-locked state according to FIG. 2a, the bolt 13 is disposed in the first holder 14; in the locked state, which is illustrated in FIG. 2b, the bolt 13 is displaced to the right into the locked position by means of the second actuator 11, the bolt 13 being disposed in the first holder 14 and, during the locking operation, being guided through the eyelet 12 and having a tip introduced into the second holder 15, which is provided on that side of the eyelet 12 which is located opposite to the first holder 14. In a locked state, the bolt 13 is mounted in the first and second holders 14 and 15, which are fixed to the second steel framework 3. The mounting of the bolt 13 is stable in relation to tension and in particular in the direction of the force of gravity, and therefore renewed actuation of the first actuator 10 can draw the eyelet 12 a distance further in the direction of the earth or ground level. As a result, the swung-shut production mold 1 is closed, i.e. the first and second mold half-shells 4 and 5 are drawn further together.

By virtue of the eyelets 12 of all the closures 7 along the longitudinal sides of the first and second steel frameworks 2 and 3 being retracted simultaneously, the two peripheries of the rotor-blade half-shells mounted in the first and second mold half-shells 4 and 5 are pushed onto one another until they are at the predetermined distance d of 1-15 mm from one another. While the first and second mold half-shells 4 and 5 are being drawn together, the adhesive-bonding agent layer 9 applied between the two peripheries of the first and second mold half-shells 4 and 5 is pushed out on the inside and outside of the rotor blades.

FIGS. 2a and 2b also depict the spacers 8. The spacers 8, in this embodiment, comprise pressure-exerting elements 8a and 8b which interact in pairs and are each mounted in a fixed position on the first steel framework 2 and on the second steel framework 3; when the production mold 1 is swung shut, the pressure-exerting elements 8a and 8b, which interact in pairs, move toward one another in a precise manner until they are in contact with one another. The pressure-exerting elements 8a and 8b can be adjusted in length and are adjusted such that, in the closed state of the production mold 1, they are in contact with one another, and cannot be moved any further toward one another, precisely when the two peripheries of the rotor-blade half-shells are at the predetermined distance of 1 cm from one another.

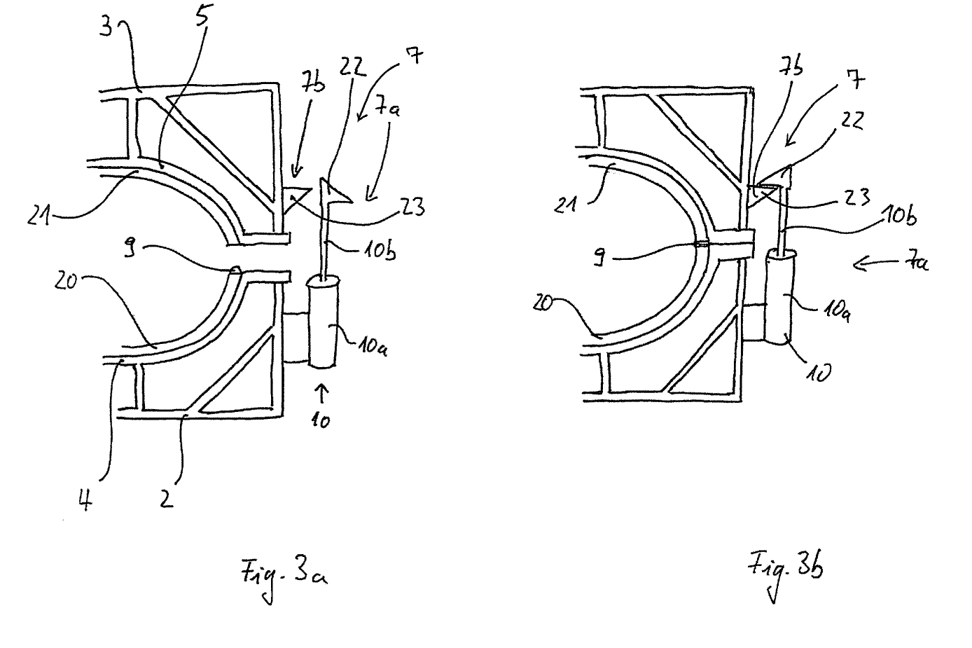

FIGS. 3a and 3b illustrate a second embodiment of the closure 7 according to the invention.

FIG. 3a illustrates a cross-sectional view of the open production mold 1 with a first rotor-blade half-shell 20 arranged in the first mold half-shell 4 and a second rotor-blade half-shell 21 arranged in the second mold half-shell 5. The swing-action peripheries of the first and second mold half-shells 4 and 5 have not been swung completely onto one another. The closure 7 can be closed automatically, as in the first embodiment. The first component 7a of the closure 7, said component being mounted on the first steel framework 2, once again has a cylinder 10a with a piston rod 10b, which is movable relative to the cylinder 10a and at the free end of which is mounted an extension arm 22, which in this embodiment is of cross-sectionally, for example triangular shape and has an extent of a number of centimeters, for example 10 to 15 cm, in the longitudinal direction. The second closure component 7b is a bearing means, which is mounted on the second steel framework 3 and projects from the outside of the second steel framework 3.

FIG. 3a illustrates the closure 7 in the open position. FIG. 3b illustrates the closure 7 in the closed position. In the open position according to FIG. 3a, the extension arm 22 is oriented away from the first mold half-shell 4. Once the swing-action second mold half-shell 5 has been swung onto the fixed-position first mold half-shell 4, a bearing means 23, which is mounted on the second steel framework 3, is arranged beneath the extension arm 22, as seen in the direction of the force of gravity. The extension arm 22 is then rotated through 180° by means of the piston rod 10b, and the extension arm 22 is therefore arranged above the bearing means 23. The bearing means 23, in turn, is of for example triangular design as seen in a cross section perpendicular to the longitudinal direction. A bearing surface of the extension arm 22 and a bearing surface of the bearing means 23 are arranged parallel to one another and are in contact with one another in the closed state of the closure 7 according to FIG. 3b.

In order to close the production mold 1, the actuator of the closure component 7a is actuated and the piston rod 10b is drawn in, and therefore the extension arm 22 and the bearing means 23 come into contact with one another on their two bearing surfaces. Actuation of the actuator 10 continues and the first and second mold half-shells 4 and 5 are forced together until the adhesive-bonding agent layer 9, which is arranged between the peripheries of the rotor-blade half-shells 20, 21, is applied in a layer thickness of 2 to 4 cm here and is compressed to a layer thickness of approximately 1-15 mm.

It is basically the case that the thickness of the layers of adhesive-bonding compound is also dependent on the rotor blade which is to be produced, and therefore the layer thicknesses are mentioned here only by way of example and other thicknesses of the adhesive-bonding agent layer 9 are also contemplated, both in respect of the initial application and in respect of the final, compressed thickness.

### LIST OF REFERENCE SIGNS

1 Production mold
2 Retaining device, e.g. steel framework
3 Retaining device, e.g. steel framework
4 First Mold half-shell
4a First Open side of the first mold half-shell
4b First periphery of the first mold half-shell
5 Second Mold half-shell
5a Second Open side of second mold half-shell
5b Second periphery of the second mold half-shell
6 Articulations
7 Closures
7a First Closure component
7b Second Closure component
8 Spacer
8a First Pressure-exerting element
8b Second Pressure-exerting element
9 Layer of adhesive-bonding agent
10 First Actuator
10a Cylinder
10b Piston rod
11 Second Actuator
11a Cylinder
11b Piston rod
12 Eyelet
13 Bolt
14 First Holder
15 Second Holder
19 Gap
20 First rotor-blade half-shell
21 Second rotor-blade half-shell
22 Extension arm
23 Bearing means
d Distance
L Longitudinal direction

What is claimed is:

1. A production mold for a rotor blade of a wind turbine comprising:
a first mold half-shell and a second mold half-shell, wherein the first mold half-shell is arranged in a first retaining device and the second mold half-shell is arranged in a second retaining device, wherein the first mold half-shell comprises a first open side and the second mold half-shell comprises a second open side, wherein the first retaining device is connected to the second retaining device in an articulated manner, wherein the first retaining device and the second retaining device are movable from an open position, in which the second mold half-shell is beside the first mold half-shell and the first open side of the first mold half-shell and the second open side of the second mold half-shell are oriented upward, to a closed position, in which the second mold half-shell is above the first mold half-shell with the first open side of the first mold half-shell oriented toward the second open side of the second open half-shell, and a plurality of closures, wherein each closure of the plurality of closures comprises a first component and a second component, wherein the first component of each closure of the plurality of closures is arranged on the first retaining device and the second component of each closure of the plurality of closures is arranged on the second retaining device, and wherein the first component and the second component of each closure of the plurality of closures is opened and closed by at least one actuator, wherein opening and closing of each closure of the plurality of closures is by at least two separate movements of either one or both of the first component and the second component.

2. The production mold as claimed in claim 1, wherein the first retaining device comprises a first steel framework and the second retaining device comprises a second steel framework.

3. The production mold as claimed in claim 1, wherein the first component of each closure of the plurality of closures comprises an eyelet and a first actuator, wherein the eyelet is driven by the first actuator, and wherein the second component of each closure of the plurality of closures comprises a bolt and a second actuator, wherein the bolt is driven by the second actuator, wherein the bolt is in the eyelet in a closed state, and wherein the bolt is out of the eyelet in an open state.

4. The production mold as claimed in claim 3, wherein the eyelet is arranged on a rod.

5. The production mold as claimed in claim 1, wherein the first component of each closure of the plurality of closures comprises a rotatable extension arm arranged on a first actuator, wherein the rotatable extension arm is oriented toward the second mold half-shell and rests on a bearing means arranged on the second steel framework in the closed state, and wherein the rotatable extension arm is oriented away from the second mold half-shell in an open state.

6. The production mold as claimed in claim 5, wherein the rotatable extension arm is arranged on a rod.

7. The production mold as claimed in claim 1, wherein the first mold half-shell comprises a first periphery and the second mold half-shell comprises a second periphery, and wherein the first mold half-shell and the second mold half-shell in the closed position form a gap running along between the first periphery and the second periphery.

8. The production mold as claimed in claim 7, further comprising a spacer arranged between the first retaining device and the second retaining device, wherein in the closed position the first retaining device and the second retaining device are spaced apart by the spacer thereby forming the gap.

9. The production mold as claimed in claim 8, wherein the spacer comprises a first pressure-exerting element and a second pressure-exerting element, wherein the first pressure-exerting element is mounted on the first steel framework, and the second pressure-exerting element is mounted on the second steel framework, and wherein the first pressure-exerting element abuts the second pressure-exerting element in the closed position.

10. A method of producing a rotor blade of a wind turbine comprising:
producing a first rotor-blade half-shell and a second rotor-blade half-shell in a production mold comprising a first mold half-shell and a second mold half-shell, wherein the first mold half-shell comprises a first open side and the second mold half-shell comprises a second open side, wherein the first rotor-blade half-shell is produced in the first mold half-shell and the second rotor-blade half-shell is produced in the second mold half-shell, wherein the first mold half-shell is arranged in a first retaining device and the second mold half-shell is arranged in a second retaining device, wherein the first retaining device is connected to the second retaining device in an articulated manner, wherein the first retaining device and the second retaining device are movable from an open position, in which the second mold half-shell is beside the first mold half-shell and the first open side of the first mold half-shell and the second open side of the second mold half-shell are oriented upward, to a closed position, in which the second mold half-shell is above the first mold half-shell with the first open side of the first mold half-shell oriented toward the second open side of the second open half-shell, and a plurality of closures, wherein each closure of the plurality of closures comprises a first component and a second component, wherein the first component of each closure of the plurality of closures is arranged on the first retaining device and the second component of each closure of the plurality of closures is arranged on the second retaining device, and wherein the first component and the second component of each closure of the plurality of closures is opened and closed by at least one actuator, wherein opening and closing of each closure of the plurality of closures is by at least two separate movements of either one or both of the first component and the second component.

11. The method as claimed in claim 10, wherein an eyelet arranged on the first component is displaced in a translatory manner in one direction, wherein a bolt arranged on the second component is displaced in a translatory manner until the bolt projects through the eyelet, and wherein the eyelet is displaced in a translatory manner in an opposite direction.

12. The method as claimed in claim 10, wherein an extension arm arranged on the first component is rotatably positioned above a bearing means arranged on the second component, and wherein the extension arm is then displaced in a translatory manner towards the bearing means.
